(19) United States
(12) Patent Application Publication
(10) Pub. No.: US 2006/0230796 A1
(43) Pub. Date: Oct. 19, 2006

(54) Electronic locking device and safety key

(75) Inventors: Ernst Keller, Wollerau (CH); Bruno Vonlanthen, Schanis (CH); Urs Späni, Schindellegi (CH); Urs Dechslin, Maur (CH); Vinzenz Beeler, Vilters (CH)

Correspondence Address: BROWDY AND NEIMARK, P.L.L.C.;624 NINTH STREET, NW, SUITE 300, WASHINGTON, DC, 20001-5303, US

(73) Assignee: Keso AG, Richterswil (CH)

(21) Appl. No.: 10/541,069

(22) PCT Filed: Dec. 15, 2003
(86) PCT No.: PCT/CH03/00818

§ 371 Date: Apr. 21, 2006

(30) Foreign Application Priority Data
Jan. 17, 2003 (CH) 67/03

(51) Int. Cl. E05B 49/00

(52) U.S. Cl. 70/278.3

(57) ABSTRACT

Disclosed is an electronic locking device comprising at least one lock unit and a safety key (1) that is provided with at least one control circuit and a transmit and receive circuit which transmits the data signals to the control circuit of the other respective unit. At least one data carrier module (7) comprising an antenna (7a) is provided. The safety key (1) encompasses a mechanical part (3) that is provided with a head (12) and a shaft (4) comprising control areas (5). The data carrier module (7) is inserted into a recess (13, 14, 15) of the mechanical part (3). The safety key (1) is embodied in such a way that it can be or is fitted with at least one second data carrier module (8, 9) which is provided with an independent antenna (8a, 9a) and a frequency that is different from that of the data carrier module. The second data carrier module (8, 9) is or can be inserted into a pocket of a cap (2) which is placed upon the mechanical part (3).

The invention relates to an electronic locking device having at least one lock unit and a security key, having at least one control circuit and a transmitting and receiving circuit which transmits information signals to the control circuit of the other respective unit, and having at least one data storage module which has an antenna, wherein the security key has a mechanical part with a shank, which has control areas, and a head, and the data storage module is inserted into a recess in the mechanical part.

Electronic locking devices of the abovementioned type have long been known. A locking device of this kind is disclosed in EP 0 559 159 A for example.

So-called Radio Frequency Identification (RFID) Systems are known in the field of electronic access control. These systems each comprise a data storage medium and a transceiver. The transceiver is installed in an electronic reader and/or in a mechatronic locking cylinder. In this case, the data storage medium is, for example, in the form of a card, a keyring pendant or a key. The data storage medium may also be installed in a clock or the like.

The transceiver supplies power to the data storage medium via an antenna. The core of the data storage medium is a data storage module which comprises an antenna module and an RFID chip. The respective access-related information is stored on this data storage module. This information is interchanged with the electronic reader or the mechatronic cylinder as soon as the data storage medium has been in the RFID field of said reader or cylinder long enough and is authorized to emit information to them if necessary. The mechatronic cylinder can be opened or the electronic reader initiates the desired function as a function of the information contained in the data storage medium. In this case, the reader or mechatronic cylinder may be operated as a “stand-alone” unit or as part of a network.

The locking device according to the invention is characterized in that the security key is formed in such a way that it can be or is fitted with at least one second data storage module which has its own antenna and uses a different frequency to that of the first data storage module. The security key of the electronic locking device according to the invention therefore comprises at least two data storage modules which are independent of one another, or can be fitted at least with a second data storage module. The second data storage module is intended for controlling a further unit, for example for controlling a time recording unit, an automatic vending machine or the like. The security key can thus be used in particular for a mechatronic cylinder and also, for example, for electronic access control, time recording or for controlling an automatic vending machine. In order to keep logistics and storage as simple as possible, the security key according to the invention is preferably formed in such a way that it can be assembled by a key-making service provider.

One development of the invention provides that a cap into which at least the second data storage module is or can be inserted is placed on the mechanical part. According to one development of the invention, this cap preferably has at least one pocket into which the second data storage module is or can be inserted. This cap is preferably composed of plastic and, according to one development of the invention, is placed, preferably latched, onto the mechanical part via the shank.

The cap is preferably formed in such a way that the second data storage module can be arranged at the side, next to an extended shank region. The second data storage module is located beneath the head of the mechanical part next to the shank, with the head of the mechanical part being smaller, with recesses at the bottom.

According to one development of the invention, the mechanical part is provided with lateral punched-out sections and a milled section in order to accommodate the antenna of the first data storage module.

The invention also relates to a security key for an electronic locking device. This key has a mechanical part which has a shank with control areas and has a head which has a recess into which a data storage module is inserted. The security key is or can be fitted with at least one second data storage module, and this second data storage module has its own antenna and uses a different frequency to that of the first data storage module.

Further advantageous features can be found in the dependent patent claims, the following description and the drawing.

One exemplary embodiment of the invention is explained in greater detail below with reference to the drawing.

In the drawings:

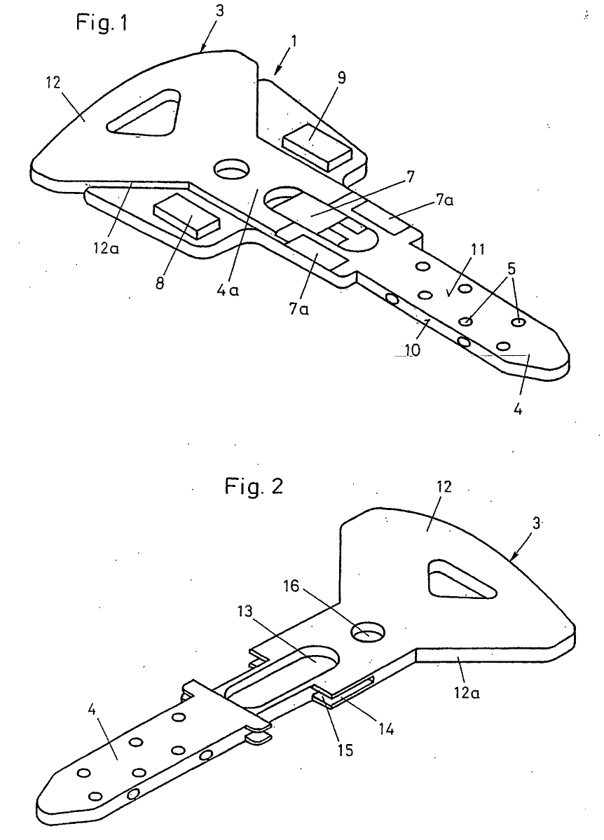

FIG. 1: shows a schematic three-dimensional view of a security key according to the invention, with parts having been cut away for illustrative reasons,

FIG. 2: shows a schematic three-dimensional view of the mechanical part of the security key according to the invention,

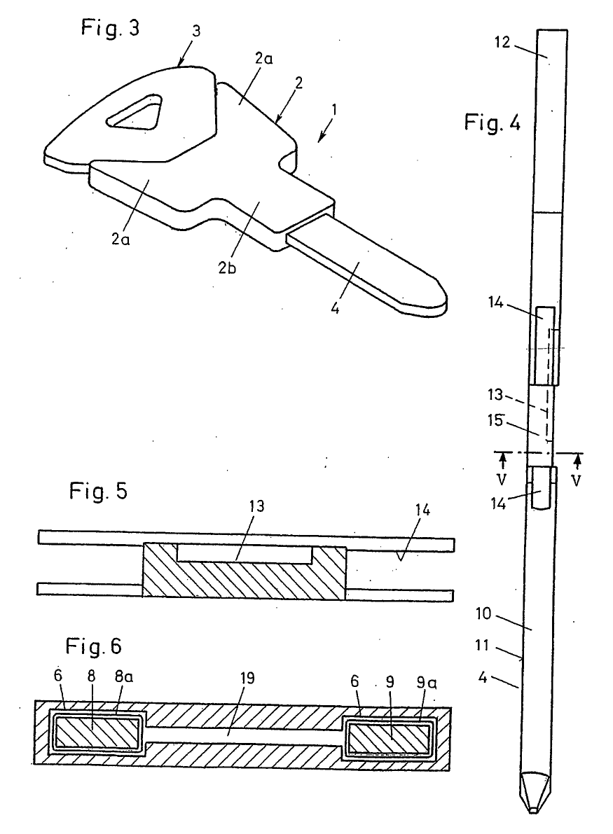

FIG. 3: shows a schematic three-dimensional view of the security key according to the invention,

FIG. 4: shows a side view of the mechanical part of the security key according to the invention,

FIG. 5: shows a section along the line V-V, and

FIG. 6: shows a cross section through the cap with two data storage modules inserted.

The key 1 shown in FIG. 1 is intended for an electronic locking device (not shown here) which has a mechatronic locking cylinder which is known per se but is not shown here. In a known manner, this locking cylinder has a motor which is controlled via a controller, for example by means of a reading device. Suitable controllers and RFID systems (Radio Frequency Identification Systems) are known by those skilled in the art and therefore do not need to be explained.

The security key 1 has a mechanical part 3 which is made from a single piece of metal and has a shank 4 and a head 12. The shank 4 is inserted into the keyway of a locking cylinder (not shown here) in a manner known per se and has bores 5 with control areas on broad sides 11 and narrow sides 10. The security key 1 is preferably a turning key. The shank 4 has an extended shank region 4a which does not have any bores 5. The head 12 is smaller than that of a purely mechanical key and has recesses 12a at the bottom which are supplemented by side parts 2a of a plastic cap 2. The head 12 and the side parts 2a thus form the bow of the security key 1.

On a broad side of the region 4a, the mechanical part 3 has an elongate recess 13 into which a first data storage module 7 is inserted. This data storage module 7 is in the form of an RFID chip and is connected to an antenna 7a which, according to FIG. 1, is arranged at the side, next to the region 4a. In order to accommodate the antenna 7a, the mechanical part 3 has lateral punched-out sections 15 and milled sections 14. A milled section 14 and a punched-out section 15 are arranged on each of the two narrow sides of the shank region 4a, so that the antenna 7a has two antenna parts which are each inserted into a milled section 14 and a recess 15. The antenna 7a is thus arranged to be as close as possible to the antenna of the mechatronic cylinder after the shank 4 is inserted into the corresponding keyway.

According to FIG. 6, the cap 2 has a recess 19 which accommodates the region 4a and part of the head 12. According to FIG. 6, a pocket 6 is made in each of the side parts 2a and accommodates a second data storage module 8 or 9. The pockets 6 are open at the top, so that the two data storage modules 8 and 9 can each be inserted into the pockets 6 from above. An embodiment is also possible in which only the data storage module 8 or the data storage module 9 is inserted. In principle, the security key 1 can also be used without data storage modules 8 and 9, or can subsequently be fitted with one or two data storage module or modules 8 and/or 9.

The cap 2 is placed onto the mechanical part 3 and latched in a recess 16 (FIG. 2). The cap 2 is placed on from the shank 4 and latched automatically when it has reached the intended position on the mechanical part 3. The cap 2 is fitted with the data storage module 8 and/or 9 before being placed onto the mechanical part 3. The antennas 8a and 9a of these data storage modules 8 and 9 are in the form of coils, for example, and are likewise inserted into the pockets 6. Arranging the data storage modules 8 and 9 at the side means it is possible for the security key 1 to be flat. The security key 1 can therefore be designed largely in the manner of a customary key. As shown in FIG. 3 in particular, the cap 2 has a relatively narrow front region 2b which covers the data storage module 7 with the antennas 7a. The data storage module 7 with the antennas 7a is thus protected by this region 2b of the cap.

1. An electronic locking device having at least one lock unit and a security key, having at least one control circuit and a transmitting and receiving circuit which transmits information signals to the control circuit of the other respective unit, and having at least one data storage module which has an antenna, wherein the security key has a mechanical part with a shank, which has control areas, and a head, and the data storage module is inserted into a recess in the mechanical part,
wherein the security key is formed in such a way that it can be or is fitted with at least one second data storage module which has its own antenna and uses a different frequency to that of the data storage module.

2. The locking device as claimed in claim 1, further comprising a cap into which at least the second data storage module is or can be inserted on the mechanical part.

3. The locking device as claimed in claim 2, wherein the cap is integrally produced from plastic.

4. The locking device as claimed in claim 2, wherein the cap is pushed onto the mechanical part via the shank (4).

5. The locking device as claimed in claim 2, wherein the head of the mechanical part is smaller at the bottom and at least the second data storage module is arranged in this region at the side, next to the shank.

6. The locking device as claimed in claim 5, wherein, at the side, next to the shank, the cap has at least one pocket for accommodating at least the second data storage module.

7. The locking device as claimed in claim 1, wherein the cap is open at an upper end thereof before being placed onto the mechanical part and at least the second data storage module is insertable into the cap through this opening.

8. The locking device as claimed in claim 2, wherein the cap is latched onto the mechanical part.

9. The locking device as claimed in claim 1, wherein, on at least one narrow side, the mechanical part has a milled section for accommodating the antenna of the first data storage module.

10. The locking device as claimed in claim 1, wherein the first data storage module is adapted to control the lock unit, and the second data storage module is adapted to control a further unit and, optionally, an access control unit, a time recording unit or an automatic vending machine.

11. Security key for an electronic locking device, having a mechanical part which has a shank with control areas and has a head which has a recess into which a first data storage module is inserted,
characterized in that said key is fitted with at least one second data storage module, and said second data storage module has its own antenna and uses a different frequency to that of the first data storage module.

12. The security key as claimed in claim 11, wherein a cap which has at least one recess for accommodating at least the second data storage module is placed on the mechanical part.

13. The security key as claimed in claim 12, wherein the cap is produced from plastic.

14. The security key as claimed in claim 12, wherein the cap is pushed onto the mechanical part from the shank.

15. The security key as claimed in claim 12, wherein the cap has laterally protruding regions beneath the head of the mechanical part, and at least the second data storage module is arranged in at least one of said lateral regions.

16. The security key as claimed in claim 12, wherein the cap has at least two pockets into each of which a data storage module is or can be inserted.

17. The locking device of claim 3 wherein said cap is pushed on to the mechanical part by said shank.

18. The locking device of claim 17 wherein the head of the mechanical part is smaller at the bottom and at least the second module is located next to the shank.

19. The locking device of claim 18 wherein said cap has at least one pocket for accommodating at least the second data storage module next to said shank.

20. The locking device of claim 19 wherein said cap is opened at an upper end thereof before being placed onto said mechanical part to provide and opening, whereby said second data storage module is insertable into the cap through said opening.
